(19) United States
(12) Patent Application Publication
(10) Pub. No.: US 2026/0131255 A1
(43) Pub. Date: May 14, 2026

(54) Kideo Device

(71) Applicant: Kideo LLC, Kirkland, WA (US)

(72) Inventor: Stevin John, Kirkland, WA (US)

(21) Appl. No.: 18/947,012

(22) Filed: Nov. 14, 2024

(51) Int. Cl. A63H 3/00; G09B 5/06; H04N 21/414; H04N 21/433

(52) U.S. Cl. CPC A63H 3/003; H04N 21/41407; H04N 21/4331; G09B 5/065

(57) ABSTRACT

The present invention relates to an interactive tablet device designed for children, which integrates physical toy interaction with digital video content using Near Field Communication (NFC) technology. The device comprises a display screen, an NFC reader embedded within a portal area, a processing unit, internal storage, and a wireless communication module. When an NFC-enabled toy figurine is placed on the portal, the NFC reader detects a unique identifier in the toy's embedded NFC tag. The processing unit retrieves video content associated with the unique identifier from local storage or, if necessary, downloads it from a cloud storage source via Wi-Fi. The device is designed to provide seamless, age-appropriate video playback based on the recognized figurine, promoting interactive and educational engagement for children. Additionally, the device's internal storage dynamically updates with new content, enabling expansion of media offerings for both non-licensed and licensed characters.

### BACKGROUND OF THE INVENTION

### Field of Invention

The present invention pertains to the field of interactive electronic devices, specifically to a tablet-like apparatus designed for use by children aged 3 to 12. More particularly, the invention relates to a device employing Near Field Communication (NFC) technology to enable a tangible interaction between physical figurines or toys and multimedia content, such as videos. Through the integration of NFC-enabled character recognition, the device facilitates dynamic media playback corresponding to each individual figurine, thereby enhancing the interactive experience for young users by combining physical toys with digital content.

### BRIEF SUMMARY OF THE INVENTION

The present invention is an interactive tablet device designed for children, enabling the integration of physical toys with digital video content through the use of Near Field Communication (NFC) technology. The device comprises a display screen, an NFC reader, a processing unit, internal storage, and connectivity options, housed within a durable, child-friendly tablet form factor.

When an NFC-enabled toy character is placed on a designated “portal” area atop the tablet, the device identifies the toy based on data transmitted wirelessly from an NFC tag embedded in the character's base. Upon identification, the device automatically retrieves a corresponding video file either from internal storage or, if necessary, downloads it from a cloud server via Wi-Fi. Once downloaded, the video is stored locally for future access without requiring an internet connection. This enables children to experience personalized video interactions with a variety of characters, including both generic and licensed figures, adding a layer of educational and entertainment value.

The invention is structured to allow content expansion, with potential future applications including games, music, and other interactive media. This unique integration of NFC technology with media playback in a standalone device enhances traditional video viewing by offering an engaging, character-driven interaction experience.

### BRIEF DESCRIPTION OF THE FIGURES

FIGS. 1.1 and 1.2: CAD designs illustrating the tablet device's precise measurements, structural layout, and design features, including the placement of the interactive portal for NFC-enabled character recognition.

FIGS. 2.1 and 2.2: Black-and-white artistic renderings providing a visual overview of the tablet's design aesthetic, ergonomic shape, and interactive components intended for child-friendly use.

FIG. 3: Flowchart depicting the sequential process of detecting toy figurine placement, reading NFC data, identifying character-specific content, retrieving and storing video content, and initiating playback on the interactive tablet device.

### DETAILED DESCRIPTION

The present invention is a child-centric, interactive tablet device that merges physical toy interaction with digital video content through Near Field Communication (NFC) technology. Designed with developmental benefits and technological simplicity in mind, this invention serves as an educational and entertainment tool for children aged 3 to 12, integrating interactive character recognition and media retrieval in a standalone device. The tablet combines NFC-enabled character identification with an intelligent storage and retrieval system, allowing children to place small, NFC-tagged figurines on the device's portal to instantly access curated, age-appropriate video content tailored to the figurine type.

### Technical Structure and Components

The tablet device features a high-resolution display screen, available in sizes ranging from 5 to 7 inches to suit different user preferences and ergonomic needs. Its construction emphasizes durability, with rounded edges and impact-resistant materials to withstand active use by young children. At the top of the screen, a dedicated “portal” area integrates magnetic alignment for secure, precise placement of NFC-tagged figurines, optimizing the user's interaction with each character.

This portal contains a highly sensitive NFC reader capable of recognizing characters by reading unique identifier data embedded in the NFC tags within each figurine. This identifier is then processed by the tablet's internal processor to retrieve matching multimedia content stored locally or to prompt a cloud retrieval if needed. The device's processing architecture supports low-latency data transfer, ensuring seamless recognition and playback for an uninterrupted interactive experience.

### Interactive Character System and NFC Technology

The invention uses NFC tags, embedded in the base of each character figurine, as the primary mode of character recognition. This NFC technology allows for a secure, wireless transfer of minimal data between the character and the NFC reader embedded beneath the portal. Each NFC tag transmits a unique identifier, which is read by the device's processor and mapped to corresponding multimedia files. This recognition and playback system is designed to be intuitive, requiring only that the child place the character on the portal area, facilitating engagement without the need for adult assistance.

Importantly, NFC technology allows for a highly controlled, contactless interaction, limiting potential data vulnerabilities and enabling a reliable, child-friendly interface. The reader's proximity is restricted to about 4 cm, ensuring that content is only triggered by direct placement of the figurine on the portal, which prevents unintentional activation.

### Content Storage and Dynamic Retrieval System

The device features an internal storage mechanism, typically an SD card or a small hard drive, capable of storing large volumes of video and multimedia files. When a figurine is placed on the portal and recognized by the NFC reader, the device's processor conducts an internal check to see if the video files associated with that character are already stored locally. If the files are present, playback is initiated immediately to maintain an uninterrupted interaction experience.

If the content is not available locally, the device automatically prompts the user to connect to a Wi-Fi network, facilitating a secure download from cloud-based storage. The downloaded content is saved to the device's internal storage for future access, allowing offline playback to prevent repeated data retrieval, which would otherwise consume bandwidth and increase response times. This intelligent, hierarchical content retrieval system ensures that the device is highly scalable, capable of storing and dynamically updating content as new figurines or characters are introduced.

### Educational Value and Child-Centric Design Advantages

This invention is built to meet the developmental needs of children in various age brackets, focusing on tactile interaction, character-driven learning, and self-directed exploration, which are critical components of early cognitive and social development. By merging physical characters with digital media, the device reinforces multisensory learning pathways—visual, auditory, and kinesthetic—offering children an engaging way to connect with educational content. Current content offerings are designed to be both entertaining and educational, such as videos on topics like animals, planets, vehicles, and insects, which stimulate curiosity and encourage exploratory learning in a safe, controlled environment.

The device also encourages cognitive development through repetitive character recognition, cause-and-effect learning, and spatial reasoning by allowing children to independently manage character placement and media engagement. The touch-free NFC technology, in combination with magnetic alignment, facilitates character interactions without precise handling, making it accessible even to younger users with developing fine motor skills. The simplicity of the NFC interface—where content is automatically triggered by the physical placement of a figurine—supports autonomous exploration, giving children a sense of control over their learning and play experience.

### Technological Distinction and Developmental Suitability

In contrast to devices that require complex setups, external consoles, or specific parental assistance, this invention is a standalone solution that minimizes reliance on additional technology. Its intuitive design, combined with content personalization through character-driven learning, provides a robust platform for children to engage with a wide array of educational themes. The device's NFC-enabled character identification ensures secure data handling, contactless interaction, and reliable functionality, making it a low-maintenance solution for caregivers and a safe, stimulating learning environment for children.

Furthermore, the cloud-connected design enables easy content updates and scalability, ensuring that the device can grow with the child's interests. This capacity to expand media offerings aligns with evolving educational content, thereby supporting ongoing learning and adaptability as the child's preferences and developmental needs change.

### Component Summary

The device's primary components include:

High-Resolution Display Screen: A durable, child-friendly touchscreen optimized for interactive media playback.

Processing Unit: Capable of rapid NFC data handling and media retrieval with minimal latency.

Internal Storage (SD card or Hard Drive): For local video storage, with cloud connectivity to expand and update content libraries dynamically.

NFC Reader and Tags: Embedded in the portal and figurines for wireless character recognition, transmitting character ID data upon contact within a limited range.

Rechargeable Battery and Charging Hardware: Providing hours of uninterrupted playback and interaction, with secure charging ports designed for safe handling.

In summary, the invention uniquely leverages NFC technology in a child-friendly format that promotes interactive, autonomous learning through physical-digital media integration. By combining durable hardware, low-latency NFC recognition, and scalable cloud storage, the device provides a safe, educational, and enjoyable experience that fosters children's engagement with educational themes and encourages their independent interaction with curated media content.

The following is a conceptual Python code outline to demonstrate the functional process of this interactive tablet device, focusing on the NFC reading, content retrieval, local storage check, and video playback. This code is structured to illustrate how each primary function operates within the device.

This is a high-level prototype and assumes the existence of underlying APIs or libraries to handle NFC reading, video playback, and file management.
import time
import random
from pathlib import Path
class Interactive Tablet:
   def_init_(self):
      self.local_storage_path=Path(“/device_storage”) #Path to local storage
      self.cloud_storage=CloudStorageAPI( ) #Placeholder for cloud storage API
      self.nfc_reader=NFCReader( ) #Placeholder for NFC reader
      self.video_player=VideoPlayer( ) #Placeholder for video playback
      self.wifi_connected=False #Device Wi-Fi connection status
      def connect_to_wifi(self):
         “““Simulate Wi-Fi connection establishment.”””
         print(“Attempting to connect to Wi-Fi . . . ”)
         self.wifi_connected=True
         print(“Wi-Fi connected.”)
      def check_nfc_tag(self):
         “““Read NFC tag and return character ID.”””
         character_id=self.nfc_reader.read_nfc_tag( )
         print(f“NFC tag detected: Character ID={character_id}”)
         return character_id
      def check_local_storage(self, character_id):
         “““Check if character's video file exists in local storage.”””
         video_file_path=self.local_storage_path/f“{character_id}.mp4”
         if video_file_path.exists( )
         print(f“Video found locally for Character ID: {character_id}”)
         return video_file_path
         else:
         print(f“Video for Character ID:{character_id} not found in local storage.”)
         return None
      def download_from_cloud(self, character_id):
         “““Download video from cloud if not available locally.”””
         if not self.wifi_connected:
         self.connect_to_wifi( )
         print(f“Downloading video for Character ID: {character_id} from cloud . . . ”)
         video_path=self.cloud_storage.download (character_id, self.local_storage_path)
         print(f“Download complete for Character ID:{character_id}. Video stored locally.”)
         return video_path
      def play_video(self, video_path):
         “““Play the retrieved video.”””
         print(f“Playing video from {video_path} . . . ”)
         self.video_player.play(video_path)
         time.sleep(5) #Simulate the length of video playback
      def main_loop(self):
         “““Main function loop to monitor NFC reader and handle interactions.”””
         print(“Device is now active. Awaiting character placement on the portal . . . ”)
         while True:
         character_id=self.check_nfc_tag( ) #Simulate reading an NFC tag
         if character_id:
         #Check local storage for video file
         video_file_path=self.check_local_storage(character_id)
         #If video not found locally, download from cloud storage
         if not video_file_path:
         video_file_path=self.download_from_cloud(character_id)
         #Play the video
         self.play_video(video_file_path)
         #Pause to simulate time between NFC reads
         time.sleep(1)
class NFCReader:
   def read_nfc_tag(self):
      “““Simulate reading NFC tag and returning character ID.”””
      #Returns a random character ID for simulation purposes
      return f“character_{random.randint(1, 10)}”
class CloudStorageAPI:
   def download(self, character_id, save_path):
      “““Simulate downloading a video file from cloud storage.”””
      video_path=save_path/f“{character_id}.mp4”
      time.sleep(2) #Simulate download time
      video_path.touch( ) #Create an empty file for simulation
      return video_path
class VideoPlayer:
   def play(self, video_path):
      “““Simulate video playback.”””
      print(f“Video {video_path} is now playing . . . ”)
#Initialize and start the main interactive loop
tablet=Interactive Tablet( )
tablet.main_loop( )

### Explanation of Code Components

InteractiveTablet Class: Manages the primary operations, including reading the NFC tag, checking for the video in local storage, downloading from cloud storage if necessary, and playing the video.

connect_to_wifi( ) This method simulates connecting the device to a Wi-Fi network. In a real device, this would involve authenticating with a network.

check_nfc_tag( ) Uses the NFCReader class to simulate reading an NFC tag and retrieving a unique character ID associated with a toy figurine.

check_local_storage( ) Checks if the video corresponding to the character is available locally. If found, it returns the file path; otherwise, it returns None.

download_from_cloud( ) Simulates downloading a video file from cloud storage if the video is not available locally. This uses the CloudStorageAPI placeholder class.

play_video( ) Uses the VideoPlayer class to simulate video playback. In a real device, this would call a video player API to play the content.

NFCReader, CloudStorageAPI, and VideoPlayer Classes: Simulated versions of an NFC reader, cloud storage API, and video player. These are placeholders that simulate functionality relevant to the device's operation.

### Simulation of Operation

NFC Detection and ID Retrieval: When a toy is placed on the NFC portal, the system retrieves a character ID via the NFCReader class.

Local Storage Check: The system first checks for the character's video in local storage. If it exists, it plays the video immediately.

Cloud Retrieval: If the video is not in local storage, it prompts a Wi-Fi connection and downloads the file from a cloud source, saving it for future access.

Video Playback: Finally, the system plays the retrieved video, providing an interactive experience for the user.

This code is a basic framework and will be adjusted and integrated with actual NFC, file management, and playback APIs to operate on real hardware.

### DETAILED DESCRIPTION OF FIGURES

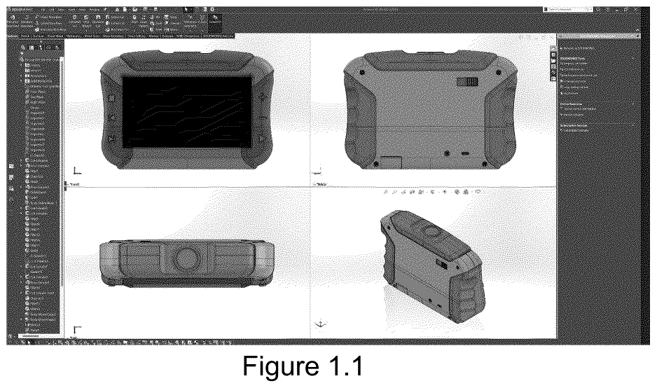

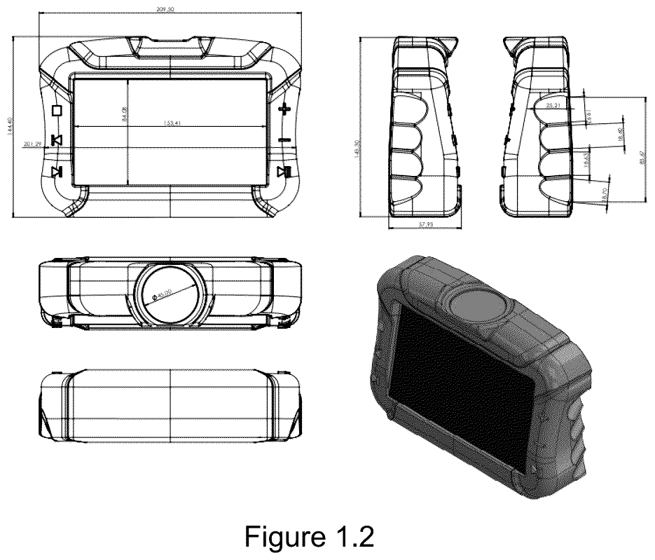

FIGS. 1.1 and 1.2 provide CAD renderings of the interactive tablet device, focusing on its physical dimensions, design layout, and key component placements. These figures show the rectangular tablet form factor with specific measurements designed for optimal use by children aged 3 to 12. Central to the design is the display screen, either 5 inches or 7 inches, which forms the main interface. Above the screen is a designated “portal” area where NFC-enabled character figurines are placed to activate corresponding multimedia content. The CAD renderings further illustrate the internal positioning of components, including the NFC reader located beneath the portal, magnetic alignment points to secure the figurine in place, and the internal storage areas for the SD or hard drive, processing unit, and battery. The structural layout and functional design are optimized for durability and ease of use, ensuring that the device remains both child-friendly and robust.

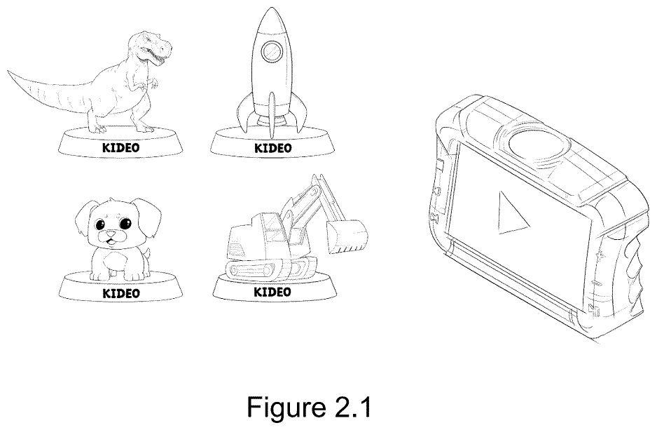

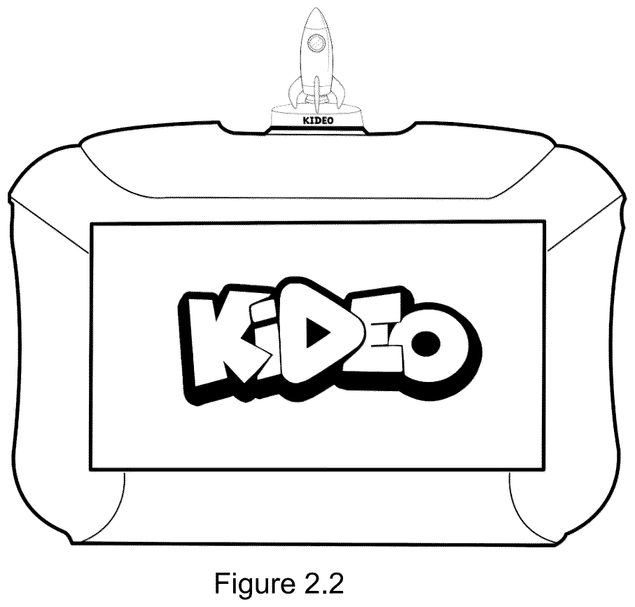

FIGS. 2.1 and 2.2 present artistic renderings in black and white, visually capturing the overall aesthetic and ergonomics of the tablet device. These illustrations show the tablet's streamlined, durable design tailored for children's hands, with rounded edges and a textured finish to provide a secure grip. In the front-facing view, the artistic rendering highlights the screen as the focal point of the device, along with the portal area positioned at the top of the screen, which serves as the interactive point for the NFC-enabled figurines. The side profile rendering emphasizes the thickness and material contours, depicting the ergonomic angles that make the device comfortable to hold or place on a surface for hands-free viewing. Together, these figures convey the device's practical and engaging design, showcasing features that are both appealing and functional for young users.

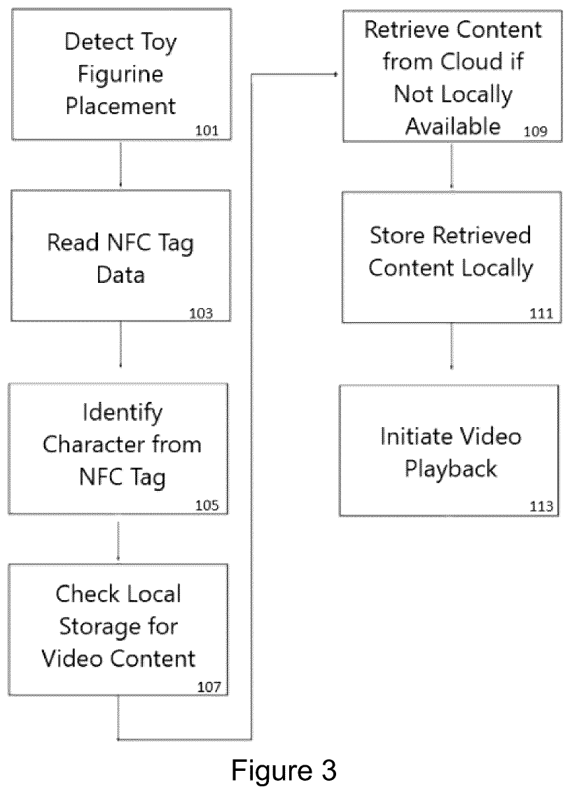

FIG. 3.101: Detect Toy Figurine Placement

Upon the placement of a toy figurine on the tablet's portal area, embedded magnets in both the figurine and the portal align to secure the figurine in place. The portal's design ensures that the NFC reader located directly beneath the portal is optimally positioned to detect the NFC tag within the figurine's base. This detection triggers the system to activate the reading mechanism, preparing for data retrieval from the NFC tag. The secure alignment prevents accidental removal or misalignment, ensuring an accurate NFC read.

FIG. 3.103: Read NFC Tag Data

Once the figurine is aligned and secured, the NFC reader is activated and begins reading the data embedded in the figurine's NFC tag. This data consists of a unique identifier that represents the specific character or object associated with the figurine. The NFC reader has a limited detection range of approximately 4 cm, which prevents interference from other nearby NFC-enabled devices or objects and ensures data accuracy.

FIG. 3.105: Identify Character from NFC Tag

The unique identifier read from the NFC tag is processed by the device's processing unit, which cross-references the identifier with a pre-configured character database. This database links each unique identifier to specific multimedia content, such as a video file, related to the character. The processing unit quickly identifies the character based on the NFC data and moves forward to verify the presence of the corresponding media content in local storage.

FIG. 3.107: Check Local Storage for Video Content

With the character identified, the processing unit checks the device's internal storage to locate the associated video file. Local storage (typically an SD card or small hard drive) is searched for a file that matches the identifier linked to the character. If the media file is found, this step prepares it for playback. If the file is not available, the system initiates a secondary retrieval process via cloud storage.

FIG. 3.109: Retrieve Content from Cloud if Not Locally Available

If the character's corresponding video file is not found in local storage, the device's wireless communication module initiates a connection to the internet, prompting the user to connect to a Wi-Fi network if needed. Upon successful connection, the processing unit accesses cloud storage, retrieves the required video file associated with the identified character, and initiates a secure download. The system is designed to handle retrieval with minimal delay, ensuring that the download process remains streamlined.

FIG. 3.111: Store Retrieved Content Locally

Once the video content has been successfully downloaded from the cloud, the processing unit automatically saves the file to the device's internal storage. This local caching ensures that future interactions with the same character figurine will not require internet access, thereby supporting an offline mode. The downloaded content is stored in an optimized format to reduce memory usage and facilitate quick access in future interactions.

FIG. 3.113: Initiate Video Playback

After confirming that the character-specific video file is accessible from local storage, the device's video playback application initiates the media playback on the display screen. The system engages a child-friendly video interface, starting the playback seamlessly, allowing the child to engage with the video content associated with the figurine. This interface is designed to be visually engaging and simple, ensuring that children can interact with the content independently.

What is claimed is:

1. An interactive tablet device for use by children, comprising:
a. a display screen for video playback;
b. a portal area configured to receive and align toy figurines;
c. an NFC reader embedded beneath the portal area to detect a unique identifier stored in an NFC tag integrated within each toy figurine;
d. a processing unit in communication with the NFC reader, adapted to identify the toy figurine based on the unique identifier;
e. an internal storage medium for storing video content associated with the unique identifier; and
f. a wireless communication module configured to connect to a cloud storage source to retrieve video content if the video content is not stored on the internal storage medium.

2. The interactive tablet device of claim 1, wherein the portal area includes magnetic alignment components configured to secure each toy figurine in place on the portal, ensuring accurate NFC reading and preventing unintentional activations.

3. The interactive tablet device of claim 1, wherein the processing unit is further configured to:
a. check the internal storage medium for the presence of video content associated with the unique identifier;
b. prompt a wireless connection if the video content associated with the unique identifier is not stored locally; and
c. download the associated video content from cloud storage to the internal storage medium once a wireless connection is established.

4. The interactive tablet device of claim 1, wherein the NFC reader is configured to read data from the NFC tag within a predefined proximity, preventing unintended data retrieval or activation of content when a toy figurine is not in direct contact with the portal.

5. The interactive tablet device of claim 1, further comprising a video player application or module that plays the retrieved video content on the display screen upon identification of the toy figurine through the unique identifier.

6. The interactive tablet device of claim 1, wherein the internal storage medium is a removable SD card, allowing for expanded memory capacity and the storage of additional content.

7. The interactive tablet device of claim 1, wherein the cloud storage source is configured to dynamically update the device's library of video content, allowing for expansion of available media associated with each toy figurine over time.

8. The interactive tablet device of claim 1, wherein the processing unit includes software or firmware that manages:
a. automatic video playback of character-specific content;
b. offline access to downloaded video content; and
c. caching of frequently accessed video files to optimize memory use and response times.

9. A method of providing interactive content to a user through an interactive tablet device, comprising:
a. receiving a toy figurine onto a portal area on the tablet device;
b. reading a unique identifier from an NFC tag embedded within the toy figurine via an NFC reader located beneath the portal area;
c. processing the unique identifier to determine if corresponding video content is stored on an internal storage medium of the tablet device;
d. if the video content is stored on the internal storage medium, initiating playback on the tablet device display;
e. if the video content is not stored on the internal storage medium, connecting to a cloud storage source via a wireless communication module and downloading the video content; and
f. storing the downloaded video content on the internal storage medium for future access.

10. The method of claim 9, wherein the act of receiving the toy figurine onto the portal area includes aligning the toy figurine with magnetic components in the portal to ensure stable placement and accurate NFC tag reading.

11. The method of claim 9, wherein the act of reading the unique identifier from the NFC tag includes limiting the NFC reader's detection range to a predefined distance, ensuring data retrieval only when the toy figurine is in direct contact with the portal area.

12. The method of claim 9, further comprising dynamically updating the content available for download from the cloud storage source, allowing for the expansion of available video content associated with new toy figurines introduced after the tablet device's initial configuration.
